(19) United States
(12) Patent Application Publication
(10) Pub. No.: US 2023/0392988 A1
(43) Pub. Date: Dec. 7, 2023

(54) TEMPERATURE SENSOR SYSTEMS AND METHODS FOR REMOTELY MEASURING TEMPERATURE USING AN OPTICAL ELEMENT

(71) Applicant: SYMPTOMSENSE, LLC, Ronkonkoma, NY (US)

(72) Inventors: Derek Peterson, South Setauket, NY (US); Mohammed Elbadry, East Setauket, NY (US)

(21) Appl. No.: 18/021,825

(22) PCT Filed: Aug. 23, 2021
(86) PCT No.: PCT/US2021/047050

§ 371 Date: Feb. 17, 2023

Related U.S. Application Data
(60) Provisional application No. 63/068,599, filed on Aug. 21, 2020.

(51) Int. Cl. G01J 5/00; G01J 5/02; G01J 5/04; G01J 5/0806; G01J 5/0808; G01J 5/08

(52) U.S. Cl. CPC G01J 5/0025; G01J 5/025; G01J 5/047; G01J 5/0806; G01J 5/0808; G01J 5/0859

(57) ABSTRACT

A system for remotely sensing a skin temperature of a person includes a housing forming an aperture on one side thereof, a temperature sensor installed inside the housing, a window fitted to the aperture and configured to relay infrared light therethrough, wherein the infrared light is emitted remotely from a person, and an optical element installed inside the housing and configured to reflect the infrared light to the temperature sensor. The skin temperature of the person is measured based on the reflected infrared light.

### CROSS-REFERENCE TO RELATED APPLICATIONS

The present application claims the benefit of and priority to U.S. Provisional Application Ser. No. 63/068,599, filed on Aug. 21, 2020, the entire content of which being incorporated herein by reference.

### FIELD

The present disclosure relates to temperature sensing systems and methods for measuring temperature. More particularly, the present disclosure relates to systems and methods for remotely measuring temperature by using an optical element.

### BACKGROUND

Outbreaks due to COVID-19 have received much attention from people because the spread rates of COVID-19 are substantially higher than other diseases. There are many symptoms related to COVID-19 and other viruses, including a fever. Thus, checking the skin temperature of a body portion of people in business establishments and residential places is critical to keeping people residing or working at the site safe from being infected with COVID-19 and other viruses. Thus, skin temperature scanners are in great demand.

However, skin temperature scanners sometimes do not sense the correct skin temperature for various reasons. Accordingly, if one infected individual passes through a temperature screener using a skin temperature scanner, he can infect many other individuals. Thus, there is a need to accurately measure skin temperature of people entering a particular location or area.

### SUMMARY

The systems and methods of the present disclosure generally relate to remotely measuring skin temperature by using a window, an optical element, and an image capturing device. Further, the systems and methods include automatically aligning a temperature sensor to a person's body part, such as a forehead or temple, to accurately measure the skin temperature. When the measured skin temperature is higher than a threshold, precautionary action can be taken, such as not permitting a person to enter a location or area to prevent potential spread of a virus or microorganism.

Provided is a system for remotely sensing a skin temperature of a person according to aspects of the present disclosure. The system includes a housing forming an aperture on one side thereof, a temperature sensor installed inside the housing, a window fitted to the aperture and configured to relay infrared light therethrough, wherein the infrared light is emitted remotely from a person, and an optical element installed inside the housing and configured to reflect the infrared light to the temperature sensor. The skin temperature of the person is measured based on the reflected infrared light.

In aspects, the skin temperature is sensed by the temperature sensor for a predetermined period.

In aspects, the temperature sensor is located between the window and the optical element. The optical element is a parabolic mirror.

In aspects, a location of the temperature sensor corresponds to a focal point of the parabolic mirror.

In aspects, the window includes a filter configured to filter lights having a wavelength ranging from 8 μm to 17 μm.

In aspects, the system further includes an image capturing device configured to capture an image of the person and installed on the one side.

In aspects, the person is at least one person.

In aspects, the system further includes a controller configured to determine whether or not the system aligns with a face of the person based on the captured image.

In aspects, the system further includes an adjustment driver configured to adjust a forward direction of the system.

In aspects, the controller is further configured to control the adjustment driver to align the system with the face of the person.

In aspects, it is determined that the system aligns with the face of the person when a line between the window and the optical element extends to an eye or forehead within the face of the person.

In aspects, an appropriate distance, which the system is capable of sensing the skin temperature of the person, is about 18 to about 36 inches.

In aspects, a diameter of the aperture is about 2 inches.

Provided is a method for remotely sensing a skin temperature of a person according to aspects of the present disclosure. The method includes remotely capturing an image of a person, determining whether or not a temperature apparatus aligns with a face of the person based on the captured image, aligning the temperature apparatus so that a temperature sensor of the temperature apparatus aligns with the face of the person, relaying, by a window affixed on a housing of the temperature apparatus, infrared light emitted from the person to inside of the temperature apparatus, reflecting, by an optical element of the temperature apparatus, the relayed infrared light to a temperature sensor of the temperature apparatus, and measuring, by the temperature sensor, the skin temperature of the person based on the reflected infrared light for a predetermined period.

In aspects, the temperature sensor is determined alignment with the face of the person when a line between the window and the optical element extends to an eye or forehead within the face of the person.

In aspects, the optical element is a parabolic mirror.

In aspects, a location of the temperature sensor corresponds to a focal point of the parabolic mirror.

In aspects, relaying the infrared light includes filtering, by the window, the infrared light having a wavelength ranging from 8 μm to 17 μm.

In aspects, the method further includes adjusting a forward direction of the temperature apparatus to align the temperature apparatus with a face of the person.

In aspects, an appropriate distance, which the temperature apparatus is capable of sensing the skin temperature of the person, is about 18 to 36 inches.

Provided is a nontransitory computer-readable medium including processor-executable instructions stored thereon that, when executed by a processor, perform a method for remotely sensing a skin temperature of a person according to aspects of the present disclosure. The method includes remotely capturing an image of a person, determining whether or not a temperature apparatus aligns with a face of the person based on the captured image, aligning the temperature apparatus so that a temperature sensor of the temperature apparatus aligns with the face of the person, relaying, by a window affixed on a housing of the temperature apparatus, infrared light emitted from the person to inside of the temperature apparatus, reflecting, by an optical element of the temperature apparatus, the relayed infrared light to a temperature sensor of the temperature apparatus, and measuring, by the temperature sensor, the skin temperature of the person based on the reflected infrared light for a predetermined period.

The details of one or more aspects of the disclosure are set forth in the accompanying drawings and the description below. Other features, objects, and advantages of the techniques described in this disclosure will be apparent from the description and drawings, and from the claims.

### BRIEF DESCRIPTION OF DRAWINGS

FIG. 1 is a perspective view of a temperature sensor system in accordance with aspects of the present disclosure;

FIG. 2 is graphical illustration showing positional relationship between a temperature sensor and the optical element of FIG. 1 in accordance with aspects of the present disclosure;

FIG. 3 is a flowchart illustrating a method for remotely measuring skin temperature of a person by using an optical element in accordance with aspects of the present disclosure; and

FIG. 4 is a block diagram for a computing device according to aspects of the present disclosure.

### DETAILED DESCRIPTION

Temperature sensor systems and methods are disclosed in the present disclosure. In particular, the systems and methods of the present disclosure provide for remotely and accurately measuring a person's skin temperature by using a window, an optical element, and a temperature sensor. The measurements are performed without contacting the person, i.e., noncontact measurement. Further, the temperature sensor system is capable of automatically adjusting the optical axis of the optical element and the window in order for the skin temperature to be measured at a specific position or body part (e.g., forehead, eyes, or therebetween). In this way, accuracy measurements may be measured with high reliability.

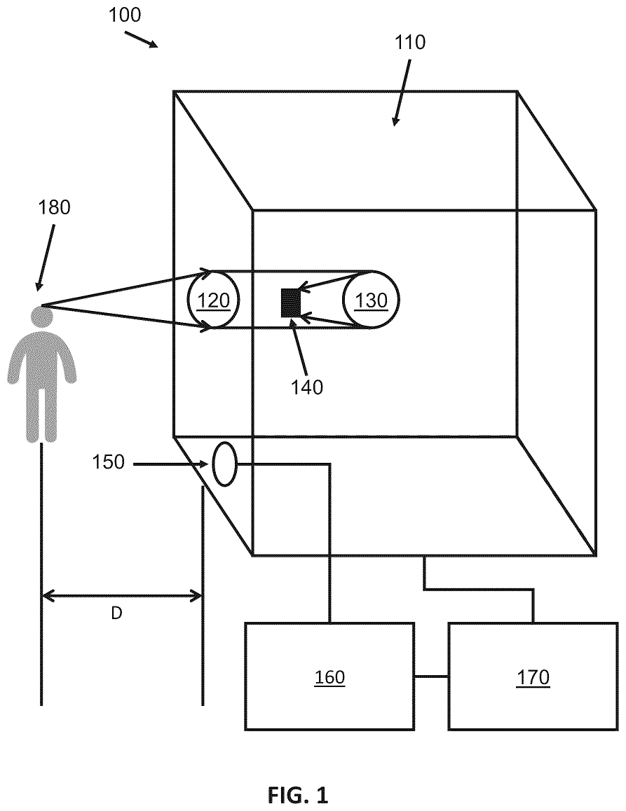

FIG. 1 is a perspective view of a temperature sensor system 100 according to aspects of present disclosure. The temperature sensor system 100 may include a housing 110, a window 120, an optical element 130, and a temperature sensor 140. The housing 110 provides protections from shocks or impacts by external objects. Further, the housing 110 may be supported by a stand (which is not shown) or affixed to a wall or any fixture so that the temperature sensor system 100 may be fixedly installed at a specific location. For example, the temperature sensor system 100 may be installed at an entrance of a business establishment (e.g., a shopping mall, government buildings, restaurants, etc.), school, a residential building, etc.

The housing 110 may have an opening in one surface thereof, to which the window 120 may be affixed or installed. The opening and the window 120 may have about 2 inches diameter through which infrared light emitted by a person 180 passes to the optical element 130. In an aspect, the diameter of the window 120 may be greater than, less than or equal to 2 inches.

In order to maintain a certain level of accuracy, the person 180 needs to be within a predetermined distance D from the housing 110. For example, the predetermined distance D may be between about 18 inches and about 36 inches. In an aspect, the predetermined distance D may be greater than 36 inches or less than 18 inches by adjusting the diameter of the housing 110.

It is noted that regardless of the skin temperature of a person, infrared light is emitted by the person. Thus, the window 120 may be an infrared filter which permits only infrared light to pass through. In an aspect of the present disclosure, the window 120 may be a filter which permits light having a specific wavelength range to pass through, such as a wavelength of about 8 to 17 micrometer (μm). In another aspect of the present disclosure, the window 120 is interchangeable with other windows to pass through light of a specific wavelength, or optical bandwidth range.

The infrared light passing through the window 120 is directed to the optical element 130, which reflects the infrared light towards the temperature sensor 140. The efficiency of the temperature sensor system 100 may be increased when the optical axis, which passes the center of the temperature sensor 140 and the center of the window 120, extends to a specific location of the face of the person 180. For example, the specific location may be the forehead, eyes, or there between.

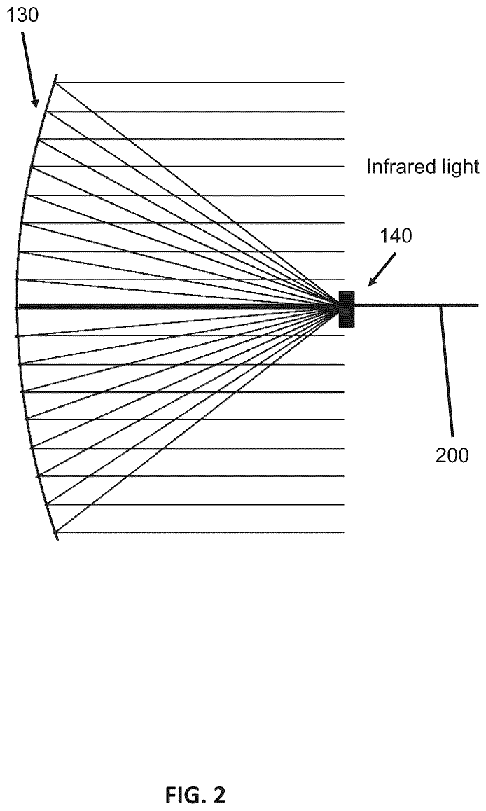

The shape of the optical element 130 may be any shape capable of reflecting and focusing the infrared light to the temperature sensor 140. In an aspect, the optical element 130 may have a concave paraboloid as shown in FIG. 2, and the temperature sensor 140 is positioned at the focal point of the concave paraboloid. In other words, when the infrared light is heading to the optical element 130 in a direction parallel with the optical axis 200, the concave paraboloid optical element 130 reflects the infrared light to the focal point of the paraboloid, where the temperature sensor 140 is located.

In another aspect, the optical element 130 may have a concave spherical surface which does not reflect the infrared light to one focal point but can reflect the infrared light within the dimension of the temperature sensor 140. In this way, the reflected infrared light may be focused within the dimension of the temperature sensor 140. In an aspect, the optical element 130 can be a mirror. The temperature sensor 140 may be located between the window 120 and the optical element 130 for the size of the temperature sensor system 100 to be reduced. The temperature sensor 140 may be a non-contact temperature sensor. The temperature sensor 140 may sense the infrared light reflected from the optical element 130, and the skin temperature of the person 180 may be measured based on the sensed infrared light. The sensed infrared light can be sensed for a short period of time to be able to measure the skin temperature of the person 180. The predetermined period may be about 0.1 second to about one minute. In aspects of the present disclosure, the predetermined period may be based on how many people are entering a particular location per minute.

The temperature sensor system 100 may further include an image capturing device 150, a computing device 160, and an adjuster 170. The image capturing device 150 may capture images of the person 180. When the image is captured, the computing device 160 receives and processes the captured image. The computing device 160 may measure a distance between the person 180 and the computing device 160. When the measured distance is within the range of the predetermined distance, the computing device 160 further processes the captured image to determine a target position of the person 180, to which the optical axis of the window 120 and the optical element 130 should extend to.

The focus position may be determined based on the predetermined positional relationship between the window 120 and the image capturing device 150. If the focus position of the person 180 does not coincide with the specific position (e.g., forehead, eyes, or an area bounded by the forehead and the eyes) of the person 180 for temperature measurements, the computing device 160 may generate and transmit a control signal to the adjuster 170.

The control signal may include information regarding yaw, roll, and pitch rotations. The adjuster 170 may rotate the housing 110 in the yaw, roll, and pitch directions according to the control signal. In a case when the person 180 is moving, the control signal may be intermittently or continuously generated according to the movements of the person 180.

In a case when there are two or more persons in the captured image, the computing device 160 may identify the persons in the captured image, determine a list of the persons based on the order in which each person in the list comes to the predetermined distance. The computing device 160 may further determine the arriving time of each person in the list based on the velocity of each person and generate the corresponding control signal so that the specific position of each person in the list is placed within the optical axis of the window 120 and the optical element 130. By automatically adjusting the yaw, roll, and pitch rotations, the temperature sensor system 100 is capable of measuring temperatures at the desired location per a predetermined period without intervention of a human operator.

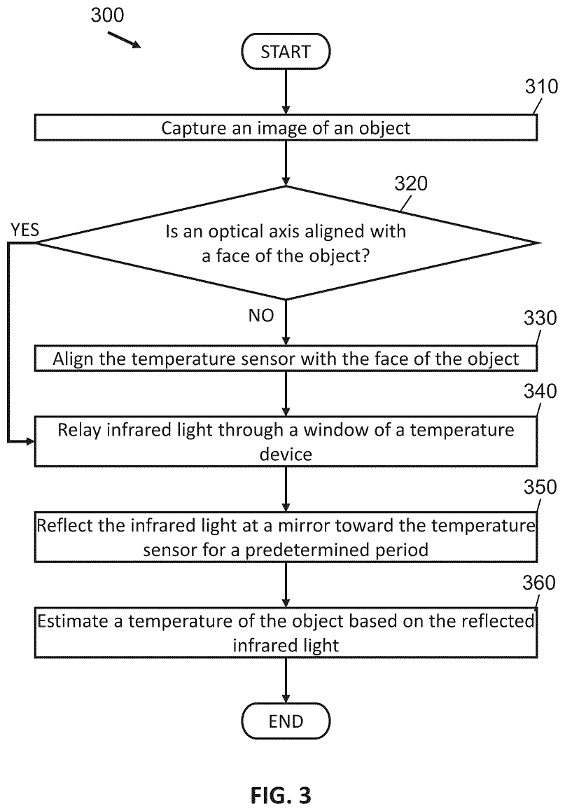

Provided in FIG. 3 is a method 300 for remotely measuring a skin temperature of a person using an optical element according to aspects of the present disclosure. The method 300 may automatically adjust an optical axis to measure the skin temperature at the target position of the person. The method 300 starts by capturing an image of the person in step 310. The captured image is processed to identify the focal point in the image, which the optical axis of the temperature sensor system 100 of FIG. 1 meets at the person. The optical axis is a line passing between the center of the window 120 and the center of the optical element 130 (e.g., mirror) of the temperature sensor system 100.

In step 320, it is determined whether the optical axis is aligned with a target area in the face. In particular, the forehead, eyes, or any place within an area bounded by the forehead and the eyes may be the target area for the temperature measurement. In an aspect, the target area may be any place of interest for the person for temperature measurements.

When it is determined that the optical axis is aligned with the target area, the method 300 proceeds to step 340. If not, the method 300 proceeds to step 330, in which the optical axis is adjusted so that the optical axis is aligned with the target area of the face. The adjustment may be made by rotating the housing 110 of the temperature sensor 140 in yaw, roll, and/or pitch directions.

In an aspect, the captured image is further processed to determine a distance between the person and the temperature sensor system 100. When the distance is within a predetermined range (e.g., about 18 inches to about 36 inches from the temperature sensor system), step 340 may be activated.

In step 340, the infrared light, which is emitted from the person, is passed through a window 120 of the temperature sensor system 100. After passing through the window 120, the infrared light is reflected by the optical element 130 in step 350. The reflected infrared light is focused at a position where the temperature sensor 140 is positioned. In an aspect, the shape of the optical element 130 may be paraboloid or spherical so that the reflected infrared light may be focused or aligned within the dimension of the temperature sensor 140. In another aspect, the shape of the optical element 130 may be any shape as far as the infrared light reflected from the optical element 130 is forwarded to the temperature sensor 140.

In step 360, the temperature sensor 140 senses the reflected infrared light and the skin temperature of the person is measured based on the reflected infrared light per a predetermined period. The predetermined period may be less than or equal to 1 second. In an aspect, the sensitivity of the image capturing device 150 may affect the predetermined period. For example, the predetermined period of the image capturing device 150 having a higher resolution is shorter than the predetermined period of the image capturing device 150 having a lower resolution.

In an aspect, the method 300 may be repeated when the temperature sensor system 100 is to measure the skin temperature for two or more people. For example, when the temperature sensor system 100 is installed at a business or government establishment, the camera 150 of the temperature sensor system 100 keeps track of persons captured in images until the skin temperature of the rearmost person is measured. When a new person is captured in a series of images, the temperature sensor system 100 continues measuring skin temperature until no people are captured in the images.

In an aspect, when the skin temperature of the people is higher than a threshold value (e.g., 100.4 F for COVID-19), the method 300 may further include sending a text or other message, and/or activating an alarm to take actions so that other people can be protected from potential infection.

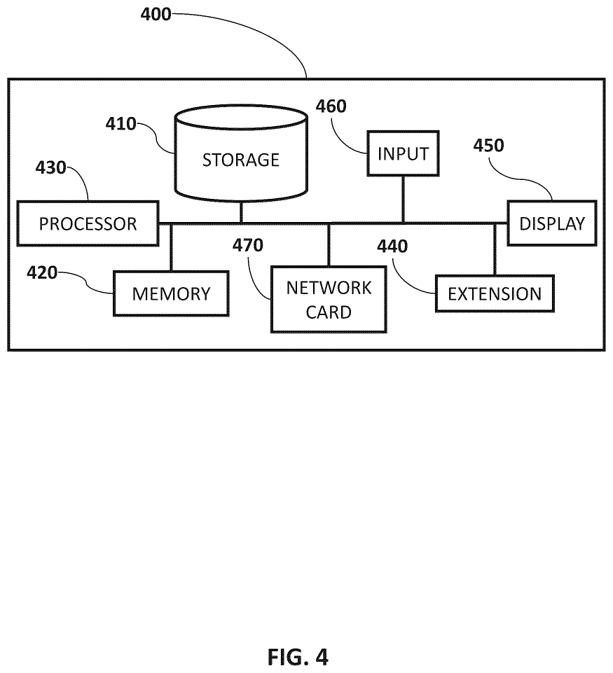

FIG. 4 is a block diagram for a computing device in accordance with aspects of the present disclosure. The computing device 400 may include, by way of non-limiting examples, server computers, desktop computers, laptop computers, notebook computers, sub-notebook computers, netbook computers, notepad computers, set-top computers, handheld computers, Internet appliances, mobile smartphones, tablet computers, personal digital assistants, video game consoles, embedded computers, and autonomous vehicles. Those of skill in the art will recognize that many smartphones are suitable for use in the system described herein. Suitable tablet computers include those with booklet, slate, and convertible configurations, known to those of skill in the art.

In some aspects, the computing device 400 includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some aspects, the operating system is provided by cloud computing. Those of skill in the art will also recognize that suitable mobile smart phone operating systems include, by way of non-limiting examples, Nokia® Symbian® OS, Apple® iOS @, Research In Motion® BlackBerry OS®, Google® Android®, Microsoft® Windows Phone® OS, Microsoft® Windows Mobile® OS, Linux®, and Palm® WebOS®.

In some aspects, the computing device 400 may include a storage 410. The storage 410 is one or more physical apparatus used to store data or programs on a temporary or permanent basis. In some aspects, the storage 410 may be volatile memory and requires power to maintain stored information. In some aspects, the storage 410 may be non-volatile memory and retains stored information when the computing device 400 is not powered. In some aspects, the non-volatile memory includes flash memory. In some aspects, the non-volatile memory includes dynamic random-access memory (DRAM). In some aspects, the non-volatile memory includes ferroelectric random-access memory (FRAM). In some aspects, the non-volatile memory includes phase-change random access memory (PRAM). In some aspects, the storage 410 includes, by way of non-limiting examples, CD-ROMs, DVDs, flash memory devices, magnetic disk drives, magnetic tapes drives, optical disk drives, and cloud computing-based storage. In some aspects, the storage 410 may be a combination of devices such as those disclosed herein.

The computing device 400 further includes a processor 430, an extension 440, a display 450, an input device 460, and a network card 470. The processor 430 is a brain to the computing device 400. The processor 430 executes instructions which implement tasks or functions of programs. When a user executes a program, the processor 430 reads the program stored in the storage 410, loads the program on the RAM, and executes instructions prescribed by the program.

The processor 430 may include a microprocessor, central processing unit (CPU), application specific integrated circuit (ASIC), arithmetic coprocessor, graphic processor, or image processor, each of which is electronic circuitry within a computer that carries out instructions of a computer program by performing the basic arithmetic, logical, control and input/output (I/O) operations specified by the instructions.

In aspects, the extension 440 may include several ports, such as one or more universal serial buses (USBs), IEEE 1394 ports, parallel ports, and/or expansion slots such as peripheral component interconnect (PCI) and PCI express (PCIe). The extension 440 is not limited to the list but may include other slots or ports that can be used for appropriate purposes. The extension 440 may be used to install hardware or add additional functionalities to a computer that may facilitate the purposes of the computer. For example, a USB port can be used for adding additional storage to the computer and/or an IEEE 1394 may be used for receiving moving/still image data.

In some aspects, the display 450 may be a cathode ray tube (CRT), a liquid crystal display (LCD), or light emitting diode (LED). In some aspects, the display 450 may be a thin film transistor liquid crystal display (TFT-LCD). In some aspects, the display 450 may be an organic light emitting diode (OLED) display. In various some aspects, the OLED display is a passive-matrix OLED (PMOLED) or active-matrix OLED (AMOLED) display. In some aspects, the display 450 may be a plasma display. In some aspects, the display 450 may be a video projector. In some aspects, the display may be interactive (e.g., having a touch screen or a sensor such as a camera, a 3D sensor, etc.) that can detect user interactions/gestures/responses and the like. In still some aspects, the display 450 is a combination of devices such as those disclosed herein.

A user may input and/or modify data via the input device 460 that may include a keyboard, a mouse, or any other device with which the use may input data. The display 450 displays data on a screen of the display 450. The display 450 may be a touch screen so that the display 450 can be used as an input device.

The network card 470 is used to communicate with other computing devices, wirelessly or via a wired connection. Through the network card 470, the image capturing device 140 of FIG. 1 may transfer captured images to the computer 400. The processor 430 may process the captured images to determine whether the face captured in the images is aligned with the optical axis of the window 120 and the optical element 130 of FIG. 1. The processor 430 may further generate and send a control signal to the adjuster 160 of FIG. 1 based on the determination via the network card 470. For example, when the face is misaligned with the optical axis of the window 120 and the mirror 130, the processor 430 may generate a control signal to make roll, yaw, and/or pitch rotation of the housing 110 so that the face captured in the images aligns with the optical axis.

The aspects disclosed herein are examples of the disclosure and may be embodied in various forms. For instance, although certain aspects herein are described as separate aspects, each of the aspects herein may be combined with one or more of the other aspects herein. Specific structural and functional details disclosed herein are not to be interpreted as limiting, but as a basis for the claims and as a representative basis for teaching one skilled in the art to variously employ the present disclosure in virtually any appropriately detailed structure. Like reference numerals may refer to similar or identical elements throughout the description of the figures.

Any of the herein described methods, programs, algorithms or codes may be converted to, or expressed in, a programming language or computer program. The terms “programming language” and “computer program,” as used herein, each include any language used to specify instructions to a computer, and include (but is not limited to) the following languages and their derivatives: Assembler, Basic, Batch files, BCPL, C, C+, C++, C #, Delphi, Fortran, Java, JavaScript, machine code, operating system command languages, Pascal, Perl, PL1, scripting languages, Visual Basic, meta-languages which themselves specify programs, and all first, second, third, fourth, fifth, or further generation computer languages. Also included are database and other data schemas, and any other meta-languages. No distinction is made between languages which are interpreted, compiled, or use both compiled and interpreted approaches. No distinction is made between compiled and source versions of a program. Thus, reference to a program, where the programming language could exist in more than one state (such as source, compiled, object, or linked) is a reference to any and all such states. Reference to a program may encompass the actual instructions and/or the intent of those instructions.

It should be understood that various aspects disclosed herein may be combined in different combinations than the combinations specifically presented in the description and accompanying drawings. It should also be understood that, depending on the example, certain acts or events of any of the processes or methods described herein may be performed in a different sequence, may be added, merged, or left out altogether (e.g., all described acts or events may not be necessary to carry out the techniques). In addition, while certain aspects of this disclosure are described as being performed by a single module or unit for purposes of clarity, it should be understood that the techniques of this disclosure may be performed by a combination of units or modules associated with, for example, a medical device.

What is claimed is:

1. A system for remotely sensing a skin temperature of a person, the system comprising:
a housing forming an aperture on one side thereof;
a temperature sensor installed inside the housing;
a window fitted to the aperture and configured to relay infrared light therethrough, wherein the infrared light is emitted remotely from a person; and
an optical element installed inside the housing and configured to reflect the infrared light to the temperature sensor,
wherein a skin temperature of the person is measured based on the reflected infrared light.

2. The system according to claim 1, wherein the skin temperature is sensed by the temperature sensor for a predetermined period.

3. The system according to claim 1, wherein the temperature sensor is located between the window and the optical element.

4. The system according to claim 1, wherein the optical element is a parabolic mirror.

5. The system according to claim 4, wherein a location of the temperature sensor corresponds to a focal point of the parabolic mirror.

6. The system according to claim 1, wherein the window includes a filter configured to filter lights having a wavelength ranging from 8 μm to 17 μm.

7. The system according to claim 1, further comprising:
an image capturing device configured to capture an image of the person and installed on the one side.

8. The system according to claim 1, wherein the person is at least one person.

9. The system according to claim 7, further comprising:
a controller configured to determine whether or not the system aligns with a face of the person based on the captured image.

10. The system according to claim 9, further comprising:
an adjustment driver configured to adjust a forward direction of the system.

11. The system according to claim 10, wherein the controller is further configured to control the adjustment driver to align the system with the face of the person.

12. The system according to claim 9, wherein it is determined that the system aligns with the face of the person when a line between the window and the optical element extends to an eye or forehead within the face of the person.

13. The system according to claim 1, wherein an appropriate distance, which the system is capable of sensing the skin temperature of the person, is about 18 to about 36 inches.

14. The system according to claim 1, wherein a diameter of the aperture is about 2 inches.

15. A method for remotely sensing a skin temperature of a person, the method comprising:
remotely capturing an image of a person;
determining whether or not a temperature apparatus aligns with a face of the person based on the captured image;
aligning the temperature apparatus so that a temperature sensor of the temperature apparatus aligns with the face of the person;
relaying, by a window affixed on a housing of the temperature apparatus, infrared light emitted from the person to inside of the temperature apparatus;
reflecting, by an optical element of the temperature apparatus, the relayed infrared light to a temperature sensor of the temperature apparatus; and
measuring, by the temperature sensor, the skin temperature of the person based on the reflected infrared light for a predetermined period.

16. The method according to claim 15, wherein the temperature sensor is determined alignment with the face of the person when a line between the window and the optical element extends to an eye or forehead within the face of the person.

17. The method according to claim 15, wherein the optical element is a parabolic mirror.

18. The method according to claim 17, wherein a location of the temperature sensor corresponds to a focal point of the parabolic mirror.

19. The method according to claim 15, wherein relaying the infrared light includes filtering, by the window, the infrared light having a wavelength ranging from 8 μm to 17 μm.

20. The method according to claim 15, further comprising:
adjusting a forward direction of the temperature apparatus to align the temperature apparatus with a face of the person.

21. The method according to claim 15, wherein an appropriate distance, which the temperature apparatus is capable of sensing the skin temperature of the person, is about 18 to 36 inches.

22. A nontransitory computer-readable medium including processor-executable instructions stored thereon that, when executed by a processor, perform a method for remotely sensing a skin temperature of a person, the method comprising:
remotely capturing an image of a person;
determining whether or not a temperature apparatus aligns with a face of the person based on the captured image;
aligning the temperature apparatus so that a temperature sensor of the temperature apparatus aligns with the face of the person;
relaying, by a window affixed on a housing of the temperature apparatus, infrared light emitted from the person to inside of the temperature apparatus;
reflecting, by an optical element of the temperature apparatus, the relayed infrared light to a temperature sensor of the temperature apparatus; and
measuring, by the temperature sensor, the skin temperature of the person based on the reflected infrared light for a predetermined period.
